(19) United States
(12) Patent Application Publication
(10) Pub. No.: US 2005/0090196 A1
(43) Pub. Date: Apr. 28, 2005

(54) Cooling fan

(76) Inventor: Jean-Guy Dube, St-Pie de Bagot (CA)

Correspondence Address: SCHWEITZER CORNMAN GROSS & BONDELL LLP, 292 MADISON AVENUE - 19th FLOOR, NEW YORK, NY, 10017, US

(21) Appl. No.: 10/934,007

(22) Filed: Sep. 3, 2004

Related U.S. Application Data
(60) Provisional application No. 60/505,569, filed on Sep. 23, 2003.

(51) Int. Cl. B01D 39/00

(52) U.S. Cl. 454/338

(57) ABSTRACT

The present invention is directed to a cooling system for agricultural buildings and, more specifically, it is directed to a support-mounted fan. The goal of this invention is to provide a fan assembly to increase the circulation of air in an agricultural building and improve the health and comfort of animals housed therein, as well as to provide for such an assembly which may be easily and conveniently positioned for such purposes.

### FIELD OF THE INVENTION

The present invention is directed to a cooling system for agricultural buildings and, more specifically, it is directed to a support-mounted fan. The goal of this invention is to provide a fan assembly to increase the circulation of air in an agricultural building and improve the health and comfort of animals housed therein, as well as to provide for such an assembly which may be easily and conveniently positioned for such purposes.

### BACKGROUND OF THE INVENTION

Cooling systems which operate by the movement of air are generally known in the art and have been used in the agricultural industry for some time in order to increase the comfort level of animals. The types of cooling systems contemplated may consist of air conditioning units, fans, cool mist devices, etc . . . However, not all the above are appropriate or effective to use in large agricultural buildings.

It is not practical nor economical to use traditional air-conditioning methods to cool down large agricultural buildings. Due to the size of agricultural buildings, the size and power of the air conditioning devices must be considerable in order to be effective, and the cost of operating them is substantial. Furthermore, existing agricultural buildings are generally not designed to support bulky air conditioning devices and the lack of sufficient insulation and the many openings in a building make the use of air conditioning devices uneconomical.

An alternate, more cost-effective form of cooling system to air-conditioning devices is the small indoor fan. The fan cooling system is based on the principle of removing warm static air from around the animal and replacing it with cooler air. Smaller fans are preferred to large fans because they offer a greater number of options for use. For example, the small fan can be mounted to screened and louvered windows located on the sidewalls of the agricultural building. This positioning is chosen to create a wind tunnel to cool down the animals. A disadvantage of the small window fan is that, due to the small size of the blades, the amount of airflow dramatically decreases at downstream locations. This is because of the conical nature of the airflow combined with the relatively small amount of air mass that can be moved using small blades on the fan. In order to move a large amount of air mass, many window fan assemblies would be needed, requiring a large amount of electricity to operate this type of cooling system. A disadvantage of wall-mounted fans is that they blow air from the side, thus the animals closer to the fan tend to disrupt the flow of air, causing animals that are farther away to be cooled less effectively. In certain situations, agricultural buildings consist only of a framed structure and a roof, thus making it impossible to use wall-mounted fans.

Other forms of cooling systems are also found in the prior art. For example, U.S. Pat. No. 6,578,828 is directed to a device and system for sheltering livestock and, more specifically, to a programmable system for efficiently using evaporating cooling devices to create a comfortable environment for the animals. This livestock cooling system comprises a structure consisting of a roof and at least one electrically-powered fan creating an air stream and means for injecting water droplets into the air stream of the fan. The disadvantage of this type of fan cooling system is that in order to be effective, it must remove the excess water in the air. As the temperature of animals and persons increase, their bodies respond by eliminating the excess water through perspiration. Thus, the surrounding air absorbs these water molecules. The airflow created by fans helps dissipate the saturated air near the surface of a person's or animals body and replaces it with unsaturated air. However, the system described in this patent adds water into the air thus increasing the amount of saturated air near a person or animal instead of solely removing it. Furthermore, depending on the amount of water sprayed into the air, the surrounding of the agricultural building, animal bedding and animals can become wet. Also, adding water into the air increases the humidity and moisture and creates unpleasant conditions. Furthermore, excess water in the air can lead to dampness and mould.

U.S. Pat. Nos. 6,244,281 and 6,244,821 disclose a low-speed cooling fan to cool individuals in large industrial buildings. This large fan produces a column of air approximately 20 feet in diameter, and must be attached to a support that is mounted to the ceiling. Due to the size and weight of this type of low-speed cooling fan, the support structure required is considerable. The structure and rafters of existing agricultural buildings are usually not adequate to support the excess weight of such a fan. Considerable renovations are often necessary to ensure that the addition of such a fan does not cause any safety problems and for compliance with local construction code requirements. Consequently, there is a limited number of locations where such a fan can be placed, and the number of such fans as can be positioned in an agricultural building is usually limited to one. Such limitations may prevent the optimum positioning of fans for the purpose of cooling livestock. Therefore, there is a need to have a cooling system that is cost-effective, that can operate efficiently within the constraints of existing agricultural buildings, and that may be conveniently and economically located in the most optimum locations for cooling.

### SUMMARY OF THE INVENTION

The present invention is directed to a cooling system for animals in an agricultural building.

Another object of this invention is to provide a cooling system comprising a fan assembly that can be used in any type of agricultural building without the need to alter the support structure of the building to account for the extra weight of the fan systems known in the art.

A further object of this invention is that the fan assemblies contemplated by the present invention can be positioned in optimal locations attached to supports that are in turn attached to the floor of the agricultural building and otherwise not supported from a roof structure.

A still further object of the present invention is to have a fan assembly blow air downwards and through adjustable diffusers, aimed at providing effective control over the direction of the airflow.

### BRIEF DESCRIPTION OF THE FIGURES

FIG. 1 is a detailed view of the cooling system assembly comprising the fan mounted on a support;

FIG. 2 is a detailed view of the support;

### DETAILED DESCRIPTION

The foregoing objects and advantages of the present invention will become more readily apparent from the following detailed description of the preferred embodiments made in reference to the attached figures.

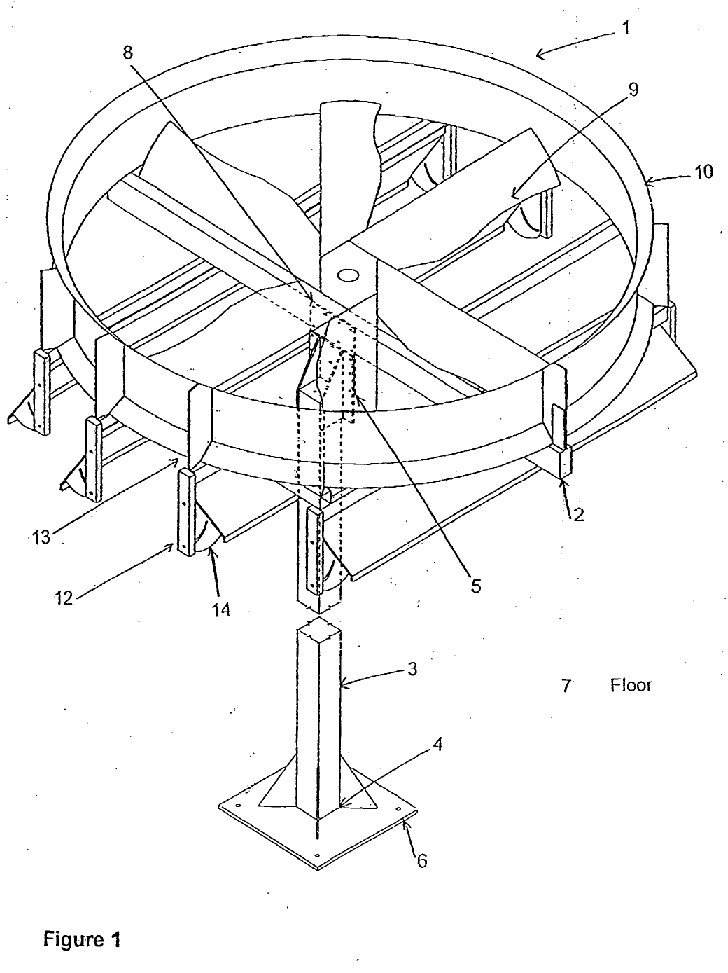

Referring now specifically to the figures, FIG. 1 shows a fan assembly (1) and its main components, as contemplated in the present invention.

The assembly comprises a horizontal support means (2), attached to a vertical support means (3). The vertical support means (3) has a first end (4) and a second end (5); the first end (4) having a horizontal base (6) securably attached to the floor (7) of an agricultural building; and the second end (5) of the vertical support means (3) having an attachment means (8) for connection to the horizontal support means (2).

The fan (11) comprises a plurality of blades (9) enclosed within a frame (10). In one embodiment, the frame (10) takes on an oblong configuration. There is also a an adjustable diffuser (12) securably attached to the frame (10). In one preferred embodiment, the adjustable diffuser (12) includes elongated channels (13), each having a side surface that is machined or fabricated to include a regulating vent (14) at its extremities.

In another embodiment of the invention, a diffuser includes a body, a pair of prongs extending from the body, a vane unit and a projection extending from the body.

In yet another embodiment of the invention, a diffuser includes a body comprising a first cylindrical portion, a second cylindrical portion and a third cylindrical portion. The third cylindrical portion has a diameter that is smaller than the diameter of the second cylindrical portion and the second cylindrical portion has a diameter that it smaller than the diameter of the first cylindrical portion. The second cylindrical portion fits within the first cylindrical portion and the third cylindrical portion may fit within the second cylindrical portion. Turning of the cylindrical portion will cause the airflow to increase and decrease and as such a person can control the amount of cool air entering into the agricultural building. However, persons of ordinary skill in the art will understand that the adjustable diffusers can be of a wide variety of configurations and dimensions, as far as the structural integrity of the channels is not compromised.

A rotatable shaft (not shown) is securably attached to the horizontal support means (2) such as to allow for rotational movement about the vertical axis, and a motor (not shown) is secured to the horizontal support means (2) in such a way that, when operated, it causes the rotatable shaft to rotate about the vertical axis and further causes air to flow downward and to be directed by said adjustable diffusers (12).

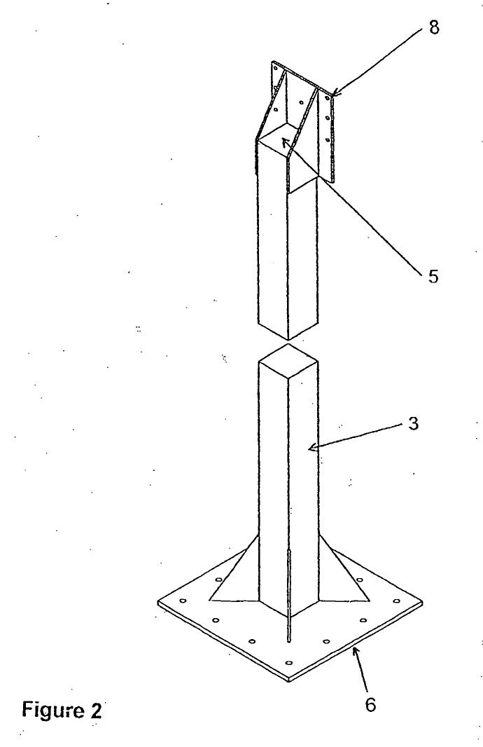

FIG. 2 shows the vertical support (3) comprising a first end (4) and a second end (5). The first end (4) is secured into the floor of an agricultural building and the second end (5) is configured so that the horizontal support means (2) can be mounted using conventional fasteners. The horizontal support (2) is adapted to allow the mounting a fan assembly (1) of any size.

Once the fan assembly (1) is in operation, the motor (not shown) causes the rotatable shaft (not shown) to rotate, making the plurality of fan blades to cause the air to move in a conical downward direction until it reaches the floor. Once the air reaches the floor area, it subsequently begins moving sideways in a horizontal fashion until it is redirected towards the fan assembly (1). This continuous circular motion of the air creates a more pleasant environment for the animals.

Having thus described the invention, it should be apparent that many structural adaptations may be implemented without departing from the scope of the present invention as set forth above and as described in the claims herein.

1. An apparatus for cooling animals in an agricultural building, the apparatus comprising:
an assembly having a horizontal support means; a vertical support means with a first and a second end; the first end having a horizontal base securable to the floor of the agricultural building; the second end having an attachment means for secured connection to the horizontal support means;
a frame securably attached to the horizontal support means;
a rotatable shaft securably attached to the horizontal support means such as to allow for rotational movement about the vertical axis;
a fan comprising a plurality of blades securably attached to said rotatable shaft; and
a motor securably attached to the horizontal support means that, when operated, causes the rotatable shaft and plurality of blades to rotate about the vertical axis further causing air to flow downwards and to be directed by adjustable diffusers.

2. The apparatus of claim 1 wherein there is a plurality of diffusers securably attached to the frame to direct the airflow.

3. The apparatus of claim 1, wherein the adjustable diffusers comprise a body, elongated channels and a regulating vent configured to direct airflow in a controlled means.

4. The apparatus of claim 1, wherein the horizontal support means and vertical support means are made of steel.

5. The apparatus of claim 2, wherein the horizontal support means and vertical support means are made of steel.

6. The apparatus of claim 3, wherein the horizontal support means and vertical support means are made of steel.

7. Use of the apparatus of claim 1 to cool livestock in an agricultural building.

8. Use of the apparatus of claim 2 to cool livestock in an agricultural building.

9. Use of the apparatus of claim 3 to cool livestock in an agricultural building.

10. Use of the apparatus of claim 4 to cool livestock in an agricultural building.
